(19) United States
(12) Patent Application Publication
(10) Pub. No.: US 2001/0056391 A1
(43) Pub. Date: Dec. 27, 2001

(54) Method and apparatus for managing and optimizing stock options

(76) Inventor: Frederick J. Schultz, Darnestown, MD (US)

Correspondence Address: DONALD R. JOHNSON, PRESIDENT, OPTIONWEALTH, INC., 1395 PICCARD DRIVE SUITE 240, ROCKVILLE, MD, 20852, US

(21) Appl. No.: 09/759,337

(22) Filed: Jan. 16, 2001

Related U.S. Application Data
(60) Provisional application No. 60/176,032, filed on Jan. 14, 2000.

(51) Int. Cl. G06F 17/60

(52) U.S. Cl. 705/36; 705/26; 705/37

(57) ABSTRACT

The present invention relates to stock options, and more specifically to a method and system for managing and optimizing stock options via a communications network. In an embodiment of the present invention, a method of optimizing the value of stock option grants using a communications network includes: receiving an option-exercising scenario for a stock option grant; calculating an estimate for the option-exercising scenario for the stock option grant; comparing the estimate for the option-exercising scenario for the stock option grant against an estimate based on a standard strategy option-exercising scenario; and calculating an optimal strategy to maximize the value of the stock option grant based on one of the estimate for the to option-exercising scenario for the stock option grant and the estimate based on the standard strategy option-exercising scenario.

### PRIORITY INFORMATION

This application claims priority to Provisional U.S. Pat. Application Serial No. 60/176,032, entitled METHOD AND APPARATUS FOR MANAGING AND OPTIMIZING STOCK OPTIONS, filed Jan. 14, 2000, the disclosure of which is hereby incorporated by reference in its entirety.

### TECHNICAL FIELD

The present invention relates to stock options, and more specifically to a method and system for managing and optimizing stock options via a communications network.

### BACKGROUND

In today's competitive labor market, companies are granting significant amounts of stock options to hire and retain employees. Because of the increase in grants of stock options, advisors and optionees need a set of decision-making tools that enable each of them to accurately determine the value of those options and provide a level of education necessary to understand what is probably the optionee's largest asset. In addition, a resource that predisposes these optionees to seek advice from a competent advice source is also needed.

The use of stock options has increased significantly in recent years. Historically, companies have reserved stock options for senior management. Recently, however, companies have been granting stock options to employees below the senior management level to attract and retain key employees. Approximately 19 million Americans currently receive stock options as part of their regular compensation packages, and that number is currently growing at 40% per year. In the short term this rate could increase substantially with pending bipartisan legislation referred to as the “Wealth Through the Workplace Act”. In addition, stock options are becoming a greater percentage of an employee's compensation. The Worldwide Total Remuneration Report 2000 from Towers Perrin, indicated that long-term incentive compensation for the large corporate chief executive officers accounted for approximately 90% of their compensation. While, this percentage undoubtably will fluctuate from year-to-year, based on prevailing compensation allocation models, stock options are expected to remain a significant portion of employee compensation for quite some time. Recent surveys show, however, that most option holders, and, as a result, employers, are not realizing the greatest potential benefits from the options that are being granted, since the holders tend to exercise their options immediately after they vest, and then sell the stock acquired upon exercise. By doing so, option holders tend to lose part or all of the benefits of the options and tax advantages inherent in the employee stock option program. As a result of this loss of value, employers' returns on their often-significant investments in employee stock option programs are reduced. Further, this strategy reduces the link between the future success of the company and the long-term personal financial success of the employee.

With their 622 billion in-the-money dollars, America's 19 million employee stock optionees represent one of the most highly prized and pursued markets in the new economy, but this market has yet to be penetrated effectively. Statistically, options represent the largest portion of an individual's net worth, but because of their complexity, options are the least understood and most poorly managed asset, by both optionees and professionals alike.

Financial institutions attempting to penetrate this market have succeeded to the extent that 25% of the net asset growth of the larger full service broker-dealers comes from assets acquired by working with optionees to either retain their company stock or transition it into alternative investments. Despite this success, studies have shown that, in fact, only 12% of the approximately 19 million employee stock option recipients seek professional financial advice or are effectively approached by financial professionals.

The primary reason that the employee stock option market penetration is sub-optimal is because current approaches to communication with the optionee mistakenly focus on execution and transition of options to cash rather than focusing pro-actively on the optionee's decision-making process and longer-range goals. The typical large financial organization implants an execution tool into the employer's intranet under the belief that this technology alone can funnel assets back to the broker-dealer. As the financial firms now realize, this approach is flawed because the optionees use the technology “in a vacuum,” with no real and much less-lasting relationship with the firm or its advisors.

This old technology model puts the broker in a position of an order taker, and in that role, the likelihood of retaining assets within the advisor's firm is quite low. This because by the time the optionee makes the decision to exercise, the optionee has already made a decision on what to do with the proceeds; this complicates the role of the advisor by putting the advisor immediately on the defensive should the advisor attempt to change the client's mind.

A more useful approach is for a financial consultant to successfully assist an optionee with what is perceived as the optionee's largest problem, namely the successful utilization of the optionee's employee stock options, and hopefully then the rest of the assets will follow as the advisor/client relationship develops over time.

The financial consultant's ability to standout as a trusted advisor increases as the advisor's knowledge of complex financial problems/investments and efficient optimal solutions becomes apparent. In most broker-dealer firms, only five percent or less of the advisors actually work with optionees on a day-to-day basis. For the advisor to standout the advisor needs to be able to:

compress time by using tools to tabulate and store specific information in a fraction of the time previously needed for each client, literally turning hours into minutes;

“cash in” on their competency and attract groups of clients in addition to individuals, thus dramatically expanding their business;

benefit from having an organized training program to follow and will more easily transition into the search for option assets; and

serve more optionees and attract more assets by obtaining the optionee's permission to help solve one of the optionee's biggest problems.

The opportunity for those financial service firms that commit to adopting such an approach could be enormous especially given that a majority of the 17 million optionees who do not seek professional advice control a third of the “in-the-money” stock options. Thus, assuming only a nominal asset management fee of 50 basis points would create a revenue of over $1 billion annually for the broker-dealers. This is an annuity stream that grows over time and does not include the additional “hidden assets” of the optionee that would be attracted to the financial institution.

The traditional methods of valuing stock options, such as simply using the Black-Scholes model, are not well suited to provide a complete analysis of the value of employee stock options, particularly when dealing with private or newly public companies. In particular, the Black-Scholes model and other traditional methods do not take into account a number of important factors, such as:

the presence or lack of a public market or trading history for the option and/or the stock acquired upon exercise of stock options;

the inability in most cases to provide a riskless hedge, thus, allowing for arbitrage which violates the pricing model;

the inability to exercise or sell because of extended vesting schedules and restricted exercise periods;

other option agreement restrictions such as no acceleration of vesting upon a change of control of the employer or forfeiture of vested shares on termination of employment;

marginal utility and value of the stock options, which considers the personal financial situation of the individual holding the stock options; and

tax implications of employee stock options, which are taxed at the time the options are exercised, including alternative minimum tax calculations.

Unfortunately, most optionees and advisors currently are unable to make the best decision regarding the disposition of the optionees options and fall victim to “analysis paralysis.” This analysis paralysis occurs because the optionees and advisors are unable to easily, fully and completely analyze the full range of option exercising scenarios and the implications of each option exercising scenario will have on the optionees net worth. Optimal exercise of options has many implications, and requires information from the legal, accounting, and financial disciplines and sometimes support from executive management. Unfortunately, many of those optionees who exercised tended to dispose of their holdings incorrectly, which indicated either (a) the optionees and/or the optionee's advisors did not fully understand the potential value of the optionees options, or (b) the optionees were frustrated with the complexity of the surrounding issues.

### BRIEF DESCRIPTION OF THE DRAWINGS

FIG. 1 illustrates a flow diagram for a method for optimizing the value of a stock option grant, in accordance with an embodiment of the present invention.

FIG. 2 illustrates a functional block diagram of a system for optimizing the value of a stock option grant, in accordance with an embodiment of the present invention.

FIG. 3 illustrates an embodiment of a graphical display showing the calculated future stock price and probability curve associated with realizing the calculated future prices, in accordance with an embodiment of the present invention.

FIG. 4 illustrates a flow diagram for a method for tracking and optimizing the value of a stock option grant, in accordance with an embodiment of the present invention.

FIG. 5 illustrates a general network architecture on which an embodiment of the present invention can be practiced.

FIG. 6 illustrates a logical application flow for communications between a user and a system server computer, in accordance with an embodiment of the present invention.

FIG. 7 illustrates a flow diagram for a method for providing a professional advisor control interface for optimizing the value of a stock option grant, in accordance with an embodiment of the present invention.

### DETAILED DESCRIPTION

Embodiments of the present invention provide objective, reliable, and authoritative software tools and unbiased information to help the growing community of employee stock option holders and their advisors understand their option portfolio's true potential value and to analyze strategies that optimize their individual net worth. An “Option holder” is variously and interchangeably referred to herein as a grantee, an optionee, a client and a user. In an embodiment of the present invention, the method and apparatus provide subscription access to a Web based platform of objective, reliable and authoritative software tools with all of the information necessary to understand the potential value of options in one place. Embodiments of the present invention allow optionee “users” and their advisors to see the value of their employee stock option grants in real-time. In embodiments of the present invention, users are able to quickly log on, review their current stock option grants, build option-exercising scenarios, develop optimal strategies, and maximize potential values of their grants. By modeling option exercise scenarios and forecasts, the user can see the consequences of exercising, selling, or holding, including the tax implications. More importantly, the system suggests appropriate strategies to optimize the value of options specific to the user's unique financial situation.

In addition to performing the above described highly complex and time-consuming calculations in real-time, in accordance with embodiments of the present invention, the system can provide users with access to detailed tax, legal, estate planning, and other pertinent resources.

What sets embodiments of the present invention apart from the discrete professionals who traditionally assist optionees with ESOs, for example, accounting, financial, and legal professionals, is that the present invention blends the relevant professional disciplines to optimize each optionees net worth. In an embodiment of the present invention, the system and method can begin with the fundamental query of which strategy optimizes the optionee's net worth given his/her subjective and dictated constraints. The system and method can then blend the relevant interdisciplinary “best practices” to achieve the optimization. This differs from the traditional approach where the client visits the professional disciplines in turn, with each profession applying its discipline-specific paradigm. The reason the system and method of the present invention produces optimization is because we give more or less emphasis to the various discipline-specific rules-of-thumb according to the situation. For example, in comparing ESO disposition alternative, the Accounting discipline would invariably assume zero growth of a company's stock in order to “simplify” the comparison, however, this simplification obscures the true wealth-building capability of the ESO. In the present invention, the system and method never lose sight of the primary goal of optimizing the optionees total net worth, for example, the method and system can consider alternative strategies in a “holistic” manner, such as measuring the outcome of each total alternative with all its complexity. The present invention accounts for the fact that each scenario implies elements of risk as well as reward and opportunity cost as well as opportunity. The system and method consider scenarios in the context of each optionee's particular need, and present a simple “normalized” comparison of the alternatives by juxtaposing their net present values and modified internal rate of returns.

The flexibility of the present invention's architecture enables it to simultaneously support different service models. For example, in accordance with an embodiment of the present invention, one model is the classic Web host model, where the optionee or the optionee's advisor accesses the system at a host web site via the Internet and completes a single sign-on authentication protocol that tunnels through the host's corporate firewall atop the secure sockets layer (SSL). The host can be a company that has granted the stock options, for example, Intel or Microsoft, and/or a company that is merely providing the service to the optionees, for example, OptionWealth, Inc. Automatic Universal Resource Locator (URL) redirection techniques can be used to ensure that inbound connection requests are automatically upgraded to secure SSL requests. The resulting secure connection can be minimized on the task bar and effortlessly reactivated at the user's discretion. In an alternate embodiment of the present invention, an “extranet” model enables an external implementation of the system to integrate with a host's corporate intranet as a trusted participant using, for example, Intel Corporation's virtual private networking (VPN) technology. A seamless and parallel integration of the above two models can permit an optionee to interact with the system from not only the optionee's workplace, but also from the privacy of his own home using either a generic Internet Service Provider (ISP) connection or a home connection to the host's corporate intranet.

In accordance with another embodiment of the present invention, a database back-end of the system can comprise an Oracle Enterprise server cluster, such as an Oracle 8i SQLJ, executing atop a constellation of Microsoft Windows NT and UNIX-based platforms. The datadependent content of the system can be dynamically tailored to each individual user through a combination of the latest active server content technologies, while still relying heavily upon common gateway interface (CGI) technology, which incorporates software written in both Java and Perl. The Oracle 8i SQLJ technology enables the Java CGI software to transact development markup language (DML) requests against the database, while the Perl software accesses the Oracle data through the DBI:DBD package. At the same time, judicious, but simple, loadbalancing technologies can be used to maximize throughput on each optionee's transactions without expending undue CPU cycles deciding where and how to forward transparent network substrate (TNS) connection requests for DML service.

In accordance with another embodiment of the present invention, the latest data partitioning techniques can be relied on to ensure separation of sensitive financial data from unauthorized persons, whether system users with specifically delimited privileges or outside attackers endeavoring to dupe the system into disclosing sensitive data. For example, the data partitioning methodology can combine the Bell-La Padula security policy model, which is embraced by the defense community, with the Brewer-Nash Security policy model, which is relied upon by the financial community for separation of conflict-of-interest classes. The least privilege principle can underlie the system's data management infrastructure so that users (regardless of whether they are members using the system to prepare options strategies or specifically empowered administrators uploading grant data over secure channels) are able to perform authorized transactions without affecting the functionality, privacy or throughput experienced by other users.

In accordance with an embodiment of the present invention, private portfolio accounts with protected access can be established for each individual optionee by the optionee or the optionee's advisor. For example, all accounts, software tools and information resources can be hosted on servers controlled by the optionee's employer, financial service provider, or by servers controlled by a stock option management system service provider, such as OptionWealth, Inc. In accordance with embodiments of the present invention, two modes of access can be offered to the user, for example, 1) direct Internet access through a web site can be available for all subscribers, with login and password protection for the individual accounts; and 2) access through a corporate Virtual Private Network (VPN) connection directly to the corporate local Intranet servers. In the corporate VPN, an employee can simply click on the OWL icon on the employee's local net screen and access the employees personal password protected portfolio accounts. Privacy and convenience are provided to the employee while the integrity of the corporate client's network is protected. As a result, employee access to the open Internet can be restricted during the business hours of the company, if desired, without limiting employee access to their personal option accounts.

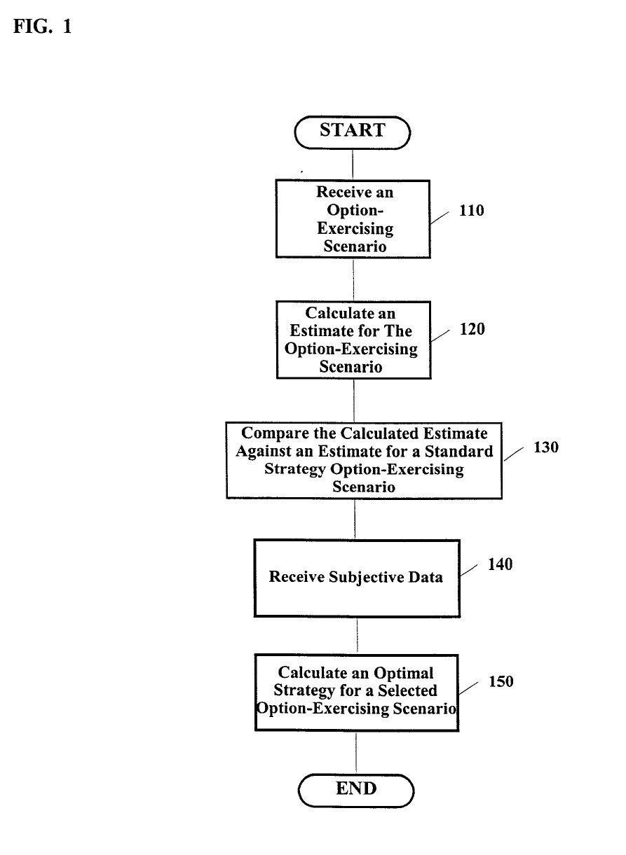

FIG. 1 illustrates a flow diagram for a method for optimizing the value of a stock option grant, in accordance with an embodiment of the present invention. In FIG. 1, one or more optionexercising scenarios can be received 110 and forecasts for each of the one or more optionexercising scenarios can be calculated 120. In an embodiment of the present invention, for the sake of efficiency and for a more user friendly interface, generally, a plurality of scenarios are requested to be entered into the method and system at this point. The forecasts for each of the entered option-exercising scenarios can be compared 130 against at least one forecast determined from at least one standard option-exercising scenario. As with the received 110 scenarios, in an embodiment of the present invention, a plurality of predetermined, standard option-exercising scenarios are calculated to provide a broader basis for comparison. Subjective data relevant to the optionee and the option grants can be received 140. This subjective data can include, for example, equity compensation information, option grant information, company specific information and option grant agreement information. An optimal forecast can be determined 150 from the forecasts for each of the entered option-exercising scenarios and the at least one forecast determined from the at least one standard option-exercising scenario.

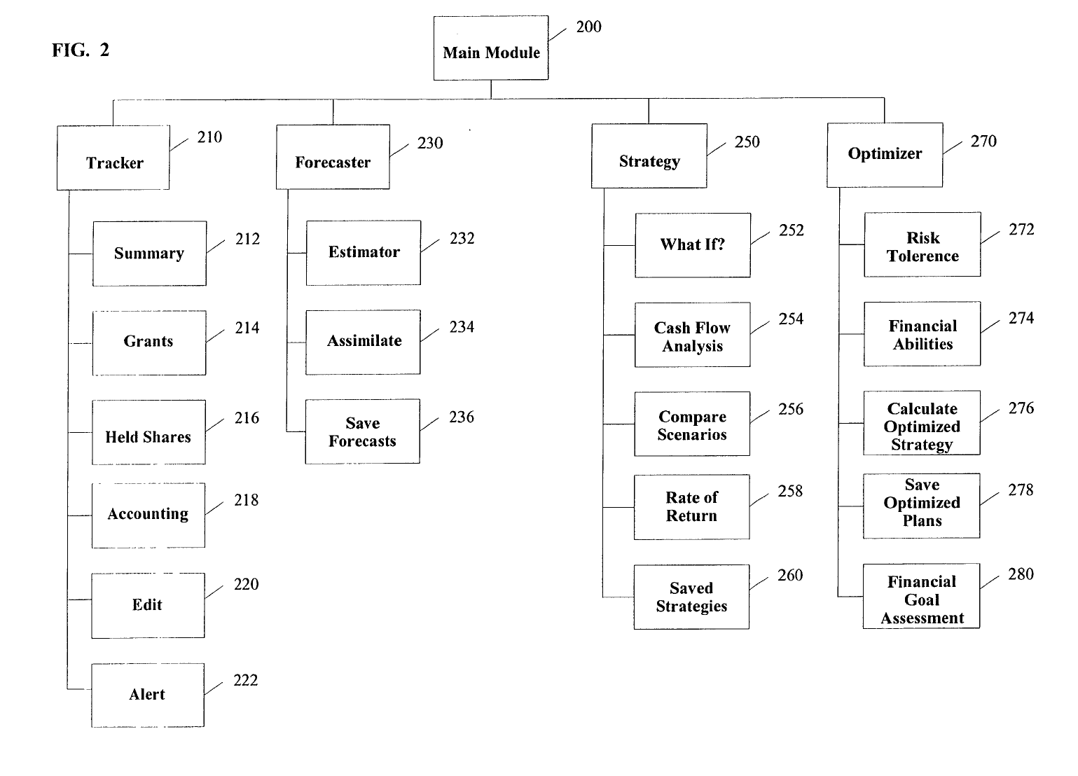

FIG. 2 illustrates a functional block diagram of a system 200 for optimizing the value of a stock option grant, in accordance with an embodiment of the present invention. In FIG. 2, the system 200 includes a main module 205 that is configured to control access into and navigation around the system 200. Accessible from the main module are tracker, forecaster, strategy and optimizer modules 210, 230, 250 and 270, respectively, which can be used to enter, track, estimate, strategize and optimize the value of the stock option grant. For example, in an embodiment of the present invention, the tracker module 210 can track stock option grant and held share portfolio information and can provide current valuations of the portfolio based on current stock prices. The tracker module 210 can provide top-level, total portfolio summary valuations as well as details about each individual stock option grant and held share groups. In addition, the tracker module 210 can provide warnings of grant vesting dates, grant expiration dates and the number of days remaining until a given stock option grant or held shares group is eligible for favorable capital gains tax treatment. The tracker module 210 also can provide a current value analysis of how well a given holding strategy is working for any given stock option grant and/or held shares group. In an embodiment of the present invention the tracker module 210 can be configured to:

Provide an expansive yet segmented knowledge base of option information for optionees and the optionee's advisors.

Receive stock option grant and held shares information;

Provide summary and detailed information displays of received stock option grants and held shares information;

Maintain the stock option grant and held shares information;

Perform current value analysis;

Perform an analysis on how an owner of the stock option grant and held shares information can achieve the owner's financial goals;

Receive sell, transfer, edit and/or delete share information;

Provide accounting information on any acquired and disposed of shares;

Enable the global editing of owner-specific data; and

Display alerts of approaching milestone dates related to the stock option grants and held shares, such as, option expiration dates and reduced capital gains threshold dates.

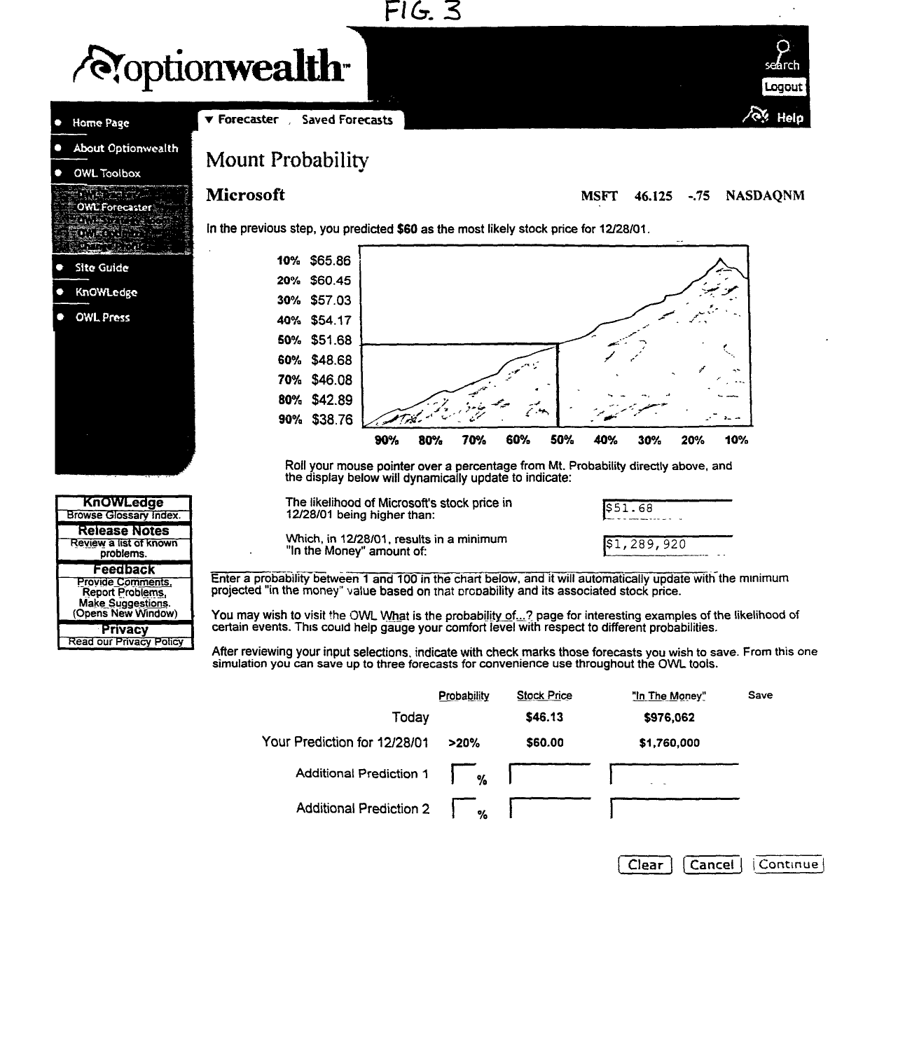

In an embodiment of the present invention, the forecaster module 230 can forecast future stock prices for a selected stock using user-input values for the future price of a stock (for example, a most likely price, a best-case price and a worst-case price) and/or historical stock performance. The forecaster module 230 also can provide graphical displays of the calculated future prices and the probabilities associated with actually achieving these prices. FIG. 3 illustrates an embodiment of a graphical display showing the calculated future stock price and probability curve associated with realizing the calculated future prices, in accordance with an embodiment of the present invention. In FIG. 2, the forecaster module 230 can store multiple price forecasts for each stock option grant for use in determining possible option-exercising strategies. In an embodiment of the present invention the forecaster module 230 can be configured to:

Receive estimates of future stock option share prices;

Receive a level selection at which to perform the analysis;

Calculate a future price curve with associated probabilities;

Display the future price curve and associated probabilities;

Save a selected future price curve; and

Display a saved future price curve.

In an embodiment of the present invention, the strategy module 250 can provide “what-if” calculations for various option-exercising scenarios and the resulting cash flows, that is, what goes for taxes, the lenders and the investor, for each of the scenarios. The strategy module 250 can also compare the what-if scenario calculations against current standard exercise strategies and display the results in present dollars ands rate of return percentages. In addition, the strategy module 250 can perform the calculations with additional variables to determine whether to borrow money or sell shares to finance the option exercise and/or get money out of the transaction. The strategy module 250 can store multiple possible strategies for each stock option grant for use in deciding on an optimal option-exercising strategy. In an embodiment of the present invention the strategy module 250 can be configured to:

Receive a selection of a company to model, which can include: grantee-specific wage and tax information, an identifier for the company; option exercise information, future stock value forecasts, exercise and sell prices, a finding method for the exercise and a number of shares to be sold.

Receive strategy exercise information;

Calculate the strategy;

Compare the strategy against a standard strategy; and

Save the strategy.

In an embodiment of the present invention, the optimizer module 270 can provide an optimized option-exercising plan that maximizes the value of the stock option grant based on the information previously entered in the tracker module 210, the forecaster module 230 and the strategy module 250, plus new information related to the investors risk tolerance and financial ability to exercise the option. In addition, the optimizer module 270 can use, as required, accounting, legal, estate planning and financial planning factors to determine the optimized option-exercising plan. In an embodiment of the present invention the optimizer module 270 can be configured to:

Receive a selected strategy;

Receive risk tolerance information, which describes the grantee's highest acceptable level of risk at which the grantee will execute the strategy;

Receive financial ability information, which describes the financial resources of the grantee that are available to execute the strategy; and

Calculate an optimized plan for the selected strategy using the risk tolerance and financial information and accounting, legal, estate planning and financial planning best practices, as required.

In FIG. 2, a tracker module 210 is coupled to the main module 205 and the tracker module 210 is shown coupled to a summary module 212, a grants module 214, a held shares module 216, an accounting module 218, a global edit module 220, and an alert module 222. In an embodiment of the present invention, the summary module 212 summarizes vested and non-vested stock option grants that are currently entered into the system. The stock option grant information can be summarized for all, or by specific, stock option grants by ISOs and NQSOs and be broken down between both vested and non-vested shares. The summary details, for both the ISO and NQSO grants, can include the total number of shares, gross value, net value and totals. Likewise, similar ISO and NQSO grant information can be provided for all held shares and can be summarized at the top level for all held stocks or by each held stock. In an embodiment of the present invention, the specific held share information can include a stock symbol, vested option shares, non-vested option shares, a total value, a gain/loss value and a gain/loss percentage. Similarly, information on other held shares, that is non-ISO and nonNQSO shares, can be provided. In addition, information on employee stock purchase plan (ESPP) can be provided including, for example, date of purchase/grant, restriction period/ vesting, number of shares and type of shares. Similarly, information on debt incurred to purchase the summanzed options can be provided including, for example, principal, accrued interest, alternate sources of debt and interest rates for the debt, and holding periods. In an embodiment of the present invention, a total net gain, that can be based on actual vested shares, can be prominently displayed to provide a user a quick reference check on how well the user's stock option grants are performing. In addition, specific stock ticker information can be provided for each stock option grant in the system as well as other user-selected stocks. This stock information can be provided on a delayed basis, for example, a fifteen minute delay, or in realtime.

The grant module 214 can be configured to display the detailed grant information for each of the stock option grants in the system. For example, this information can include, for each option grant, the grant date of the option, a total shares granted, a currently vested shares, an option price, an option expiration date, a vested net value and a vested gross value. The information can be maintained and provided organized by stock and type of grant, for example, ISO, NQSO and other. The grant module 214 can be configured to receive the entry of new stock option grants and to permit the exercise, editing and deleting of existing stock option grants already entered into the system. In an embodiment of the present invention, the grant information can include a company identifier (generally, a stock symbol), a grant type, a grant date, a number of shares granted, an option price, an option expiration date, whether the option grant is transferrable, a number of exercisable option shares remaining in the grant, an approximate stock price if the stock is private, and whether the sale of shares of the stock are restricted. In addition, the grant module 214 can be configured to provide future vesting dates of each grant as well as future vesting valuations of the un-vested grants up to a user-specified date. In an embodiment of the present invention, a date, generally in the future, and a per share value for the valuation can be received for one or more stocks. A total future vested value and specific option grant details, which are based on the received information, can be calculated and displayed. The grant module 214 also can calculate a current value of the user's options using, for example, a Black-Scholes type valuation. In an embodiment of the present invention, a standard Black-Scholes valuation for tradable stocks can be provided and a hybrid Black-Scholes valuation also can be provided, which models important differences between tradeable and nontradeable stock options. Some of the information that can be used in both Black-Scholes valuation includes a dividend yield, a risk free investment rate (such as, a US money market rate), and an implied volatility. Some of the additional information that can be used in the hybrid Black-Scholes valuation includes information about the stock option agreement events, such as, company termination or change in control; an employee's resignation, disability, death and retirement; an estimate of each of the above events occurring in a given option vesting year; employee specific tax information, for example, annual household income, applicable federal tax rate and alternative minimum tax considerations; and diminishing marginal utility information, for example, a wealth accumulation goal, a current progress toward the wealth accumulation goal excluding options, and a level of importance level for achieving multiples of the wealth accumulation goal. A grant time-line can also be maintained and displayed upon request.

In FIG. 2, the held shares module 216 can be configured to display a total gain value from all vested held shares of stock and specific details for each group of held shares and specific stock price information. The held shares module 216 can be configured to permit the entry of new held shares information, this information can include a company identifier (that is, a stock symbol), a number of held shares, an acquisition date of the held shares, an acquisition price (that is, a cost basis) for the held shares, an amount of debt incurred to acquire the held shares, and an interest rate for the debt. Information for each stock option grant can be provided, for example, organized by an option-type source, for example, ISO, NQSO and Other, of the shares and sorted by a user-selected held share information value, for example, held shares, total value, cost basis, gain/loss value, gain/loss percentage, vest date countdown and capital gains date countdown to the lowest tax rate. The held shares module 216 also can be configured to monitor and provide the progress of each group of stock option grant held shares and to compare the net worth gain/loss for the held shares with the alternative of selling on the exercise date. For example, the comparison can be performed against an alternative investment expected rate of return to determine if the held shares are outperforming the alternate investment and provides a break even stock price that is equivalent to the alternate investment. In addition, the system can receive a net worth target value and calculate a stock price, using user-specified short- and long-term capital gains tax rates, that is needed to achieve the net worth target value. The held shares module 216 further can be configured to permit a user to sell, edit and delete each individual group of held shares.

In FIG. 2, the accounting module 218 can be configured to, for example, display and enable changes to specific stock option accounting information, including viewing stock option acquisition and disposition information and electronically forwarding the same information.

In FIG. 2, the global edit module 220 can be configured to enable and accept edits to, for example, the user profile, add/edit company information and to reflect a stock split within a company.

In FIG. 2, the alert module 222 can be configured to display an alert page, which can contain information on, for example, approaching option exercise dates and option expiration dates, capital gains conversion dates, price triggers and tax alerts.

In FIG. 2, a forecaster module 230 is coupled to the main module 205 and an estimator module 232, an assimilate module 234 and a saved forecasts module 236 can be coupled to the forecaster module 230.

In FIG. 2, the estimator module 232 can be configured to enable a user to select a stock to forecast, estimate the future stock price and calculate and provide the forecasted results. In an embodiment of the present invention, the estimator module 232 can be configured to enable the selection of which stock to forecast; a date for the forecast, generally, this date is selected to be one year and a day after the option exercise in order to minimize the capital gains tax rate, however, any date can be used; at least one estimated future fair market stock value; a confidence level for the at least one estimated future fair market stock value; and a level of accuracy for the analysis. In an embodiment of the present invention, three estimates of future fair market stock values, for example, a most likely stock price, a worst case stock price and a best case stock price, can be requested and used to calculate the forecasts. In an embodiment of the present invention, the confidence level can be implemented on a graduated scale, for example, using a slide bar or other indicator to indicate a percentage-based confidence level that the user has in the entered estimated future fair market stock values. In general, a zero percent (0%) confidence level indicates no confidence in the estimated future fair market stock values, which causes the system to primarily use historical stock information; and a 100% confidence level indicates maximum confidence in the estimated future fair market stock values, which caused the system to use the exact estimated future fair market stock value and to completely ignore the historical stock information.

In FIG. 2, the assimilate module 234 can be configured to present the results of the forecasts in a user-friendly format, for example, in accordance with an embodiment of the present invention, the system can graphically display the results of the forecasts to correlate a future stock price with a probability of actually achieving the calculated stock price.

In FIG. 2, the save forecasts module 236 also can be configured to save the calculated forecasts for future review and use in determining a preferred option exercising strategy.

In FIG. 2, a strategy module 250 is coupled to the main module 205 and a what-if module 252, a cash flow module 254, a compare scenarios module 256, a rate of return module 258 and a saved strategies module 256 can be coupled to the strategy module 250.

In FIG. 2, the what-if module 252 can be configured to receive a user-selected stock and exercise information to calculate an exercise strategy. In an embodiment of the present invention, the exercise information can include the number of shares of the stock to exercise, whether the exercise is normal or early, any restricted shares, will an 83(b) election be made, an estimated value for the stock in one-year, an annualized per-share dividend, an expected yearly percentage dividend increase, the user's employment status (that is, is the user an employee of the company that issued the stock, an implied stock volatility, a sell price for the stock, and a ershare fair market value for the stock. Other information that can be received relates to how to fund the exercise of the selected options and includes exercising and selling all exercised shares (cash-less), exercising and selling only enough shares to cover the costs of the exercised shares, delivering shares, paying cash, and borrowing. Additional information that can be received relates to tax issues and includes whether the user will be making estimated tax payments, the user's expected tax yearly brackets, capital gains tax rate, yearly state tax rates, yearly local tax rates, and other applicable tax rates such as Social Security and Medicare taxes.

In FIG. 2, the cash flow analysis module 254 can be configured to provide an analysis of how the proceeds from the exercise of the strategy can be allocated. For example, in accordance with an embodiment of the present invention, the analysis can include: a gross proceeds value from the sale of the exercised stock, which, generally, does not include previously held shares that were used to exercise the stock; cash outflow values, which, generally, represent the cash needed to cover the option exercise costs; tax withholding cost values; a brokerage commission value; regular taxes not covered by the withholding costs; alternative minimum tax (AMT) costs; and a net cash value to the grantee.

In FIG. 2, the compare scenarios module 256 can be configured to provide a comparison of the grantee's net cash and portfolio value to both the grantee's “in-the-money” amount and either or both the standard Black-Scholes (BSV) valuation and the hybrid BSV amount(s) for the current options.

In FIG. 2, the rate of return module 258 can be configured to calculate a percentage rate of return that would be realized by exercising the current strategy versus both of the grantee's “in-the-money” amount and the BSV valuation amount. In general, a 100% rate of return indicates that the strategy has achieved the maximum possible rate of return.

In FIG. 2, the save strategies module 260 can be configured to save strategies for future Iuse, evaluation and optimization. In general, each strategy is saved with a descriptive name for more efficient and easier retrieval in the future by system users.

In FIG. 2, an optimizer module 270 is coupled to the main module 205 and a risk tolerance module 272, a financial abilities module 274, a calculate optimized strategy module 276, a save optimized strategies module 278 and an assess financial goals module 280 can be coupled to the optimizer module 270.

In FIG. 2, the risk tolerance module 272 can be configured to assess the user's level of tolerance to investment risk in executing an option-exercise strategy. In accordance with an embodiment of the present invention, the risk tolerance module 272 can be configured to receive, for example, current equity holdings, current fixed income holdings, subjective data in quiz format about certain investment choices the aggregated results will provide a risk profile (that is, conservative, growth, aggressive growth), subjective data on the optionee's desire to diversify the optionee's holdings, which includes a display of current holdings of stock and options and the future values of the stock and options with a slider to determine the desire. In addition, the risk tolerance module 272 can be configured to collect subjective data on saturation point, and can provide an analysis of holdings options and stock and a slider with a capture box of desired goals. The system can use this input to extrapolate a marginal utility curve.

In FIG. 2, the financial abilities module 274 can be configured to assess the user's financial resources that are available to execute the option-exercise strategy. The financial abilities module 274 can be configured to receive, for example, users income, users access to loans, mortgage, home equity, portfolio, and subjective data on leverage desire. The result will be the optimal leverage ability, which is the amount of money that can, should and the optionee is willing to borrow to accomplish his goal.

In FIG. 2, the calculate optimized strategy module 276 can be configured to calculate the results of executing the option-exercise strategy. The calculate optimized strategy module 276 can be configured to receive, for example, risk tolerance statistics, income tax data, forecasts, optionee holdings (equity, fixed income, cash, and options), optionee goals, corporate agreements, restrictions and guidelines, leverage ability and constraints, saturation utility curve and constraints, and diversification desires and constraints. The result is a number of valuations of each option tranche both subjective and non-subjective, an order in which these options should be liquidated should cash be needed at a projected date, and a calendar of exercising, holding, and selling that optimizes the optionee's equity compensation.

In FIG. 2, the save optimized strategies module 278 can be configured to save the optimal option-exercise strategy. The save optimized strategies module 278 can be configured to receive, for example, a result from an optimization model. The result can be based on certain assumptions, which can be changed and produce a different result. Each set of results can be individually saved for review at a future time under this module.

In FIG. 2, the assess financial goals module 280 can be configured to assess the user's financial goals and how executing the option-exercise strategy will help to attain these goals. The assess financial goals module 280 can be configured to receive, for example, a number of optimal strategies based on various assumptions, the ability to change some assumptions and rerun the optimization model, and view the cash flow results of an optimization.

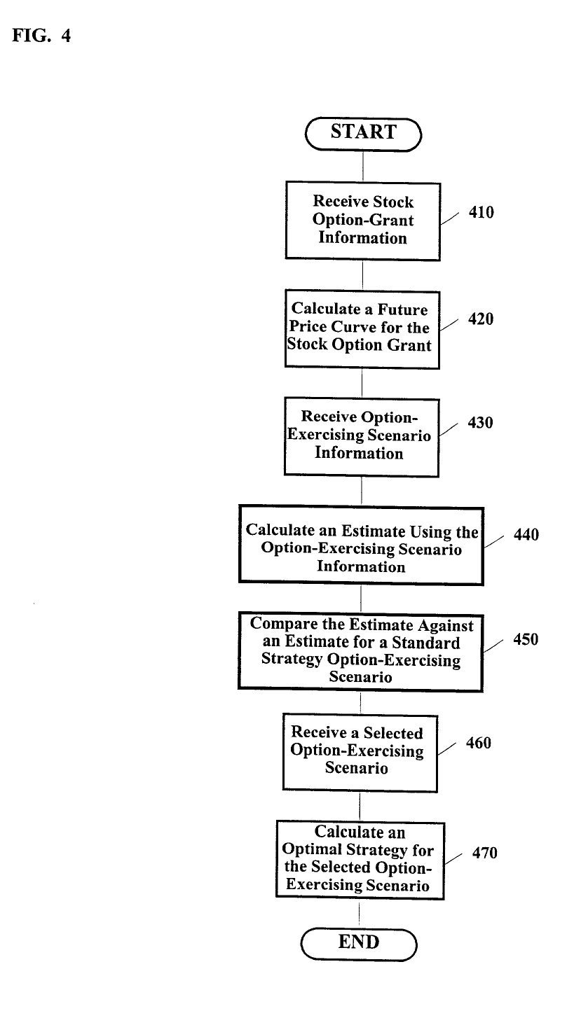

FIG. 4 illustrates a flow diagram for a method for tracking and optimizing the value of a stock option grant, in accordance with an embodiment of the present invention. In accordance with an embodiment of the present invention, in FIG. 4, stock option grant information can be received 410 and, generally, stored in a user account that has been established for the user. A future price-probability curve can be calculated 420 for a given stock and, if selected by the user, specific price points from the curve can be stored for future reference and use. Option-exercising scenario information can be received 430 and an estimate of the costs and proceeds from executing the option-exercising scenario can be calculated 440. For example, the net wealth received from the estimated option-exercising scenario can be calculated using the formula: Portfolio Value-Debt-Accrued Interest+Net Cash=Strategy's Net Value. The estimate can be compared 450 against at least one standard strategy option-exercising scenario estimate. Each standard strategy option-exercising scenario estimate can be calculated using selected optionexercising information and a standard investment industry option-exercising strategy, for example, 1) exercise, sell and invest elsewhere; 2) exercise, sell to cover costs, hold and sell; 3) exercise, borrow to cover costs, hold and sell; and 4) hold options, exercise and sell.

In the Exercise, Sell and Invest Elsewhere strategy, the system takes the assumptions in the optionee's base strategy and applies it to the following transaction: Exercise and sell all of the optionee's shares on the day of exercise. Pay all the appropriate taxes, commissions, and fees. The remaining cash is invested in a portfolio that grows at a hypothetical rate of return, which is input by the user of the system. This investment continues until what would have been the capital gains conversion date or a future date had the exercised shares been held. On this fixture date the system can sell the alternative portfolio, pay any outstanding additional taxes due and the resulting net value is then converted to today's dollars. This conversion is known as the present value of a future cash flow or payment.

In the Exercise, Sell to Cover Costs, Hold and Sell strategy the system can take the assumptions in the optionee's base strategy and applies it to the following transaction: exercise and sell enough shares to pay the cost of exercise, any withholding, and future tax liabilities from the day of exercise. The optionee now has a portfolio of shares free and clear. The optionee can hold this portfolio until the capital gains conversion date or future date. On this future date the optionee can sell the portfolio pay any outstanding additional taxes due; the resulting net value is then converted to today's dollars, that is, the future cash flow or payment.

In the Exercise, Borrow to Cover Costs, Hold and Sell strategy the system can take the assumptions in the optionee's base strategy and applies it to the following transaction: exercise and borrow the money to pay the cost of exercise, any withholding, and future tax liabilities from the day of exercise. The optionee now has a portfolio of shares free and clear. The optionee can hold this portfolio until the capital gains conversion date or future date. On this day the optionee can sell the portfolio to pay off the loan and it's accrued interest, and any outstanding additional taxes due; the resulting net value is then converted to today's dollars, that is, the future cash flow or payment.

In the Hold Options, Exercise and Sell strategy the system can hold the options (that is, do not exercise) until what would have been the capital gains conversion date should the optionee have held the shares or another future date you select. Exercise and sell all of the optionee's shares on that future date. Pay all the appropriate taxes, commissions, and fees. The remaining net cash is then converted to today's dollars, that is, the future cash flow or payment.

The method further includes receiving 460 a selected option-exercising scenario, which, optionally can be stored for future use, evaluation and optimization. The method also includes calculating 470 an optimal strategy for a selected option-exercising strategy.

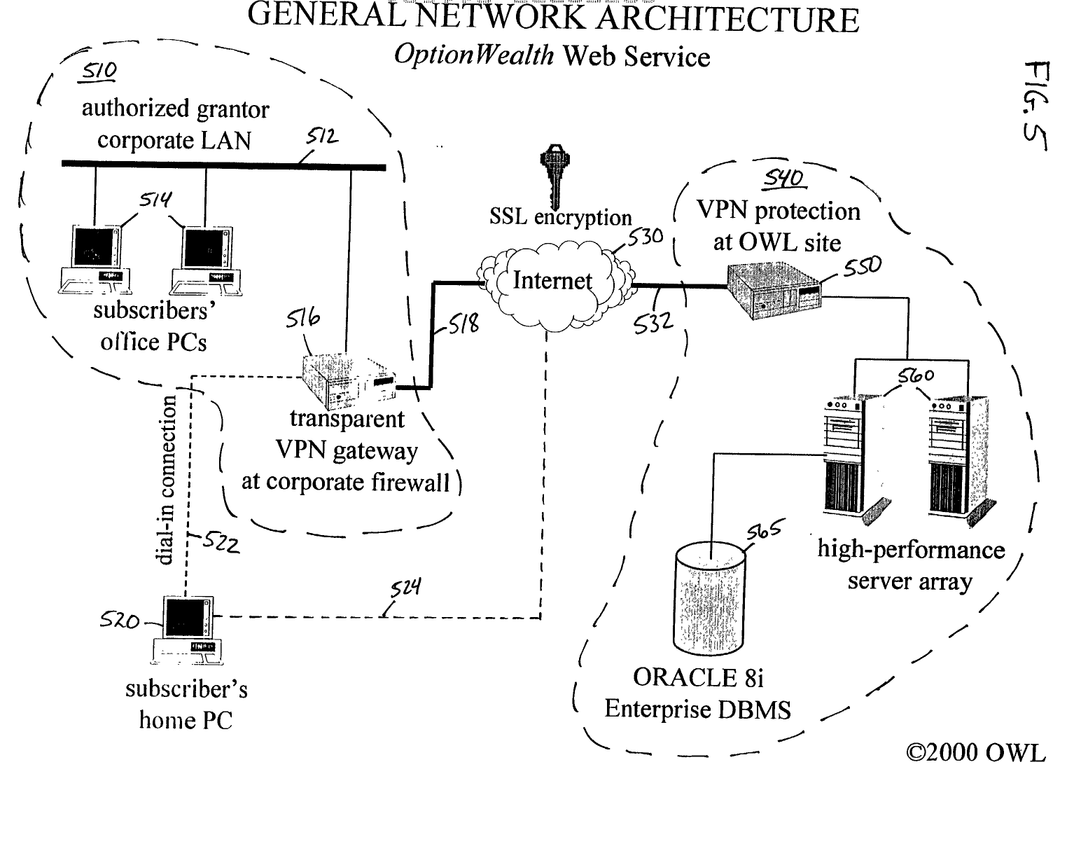

FIG. 5 illustrates a general network architecture on which an embodiment of the present invention can be practiced. In FIG. 5, an authorized stock option grantor corporate local area network (LAN) 510 can be configured to include a backbone 512, user computers/terminals 514 and a corporate gateway 516 can be communicatively coupled to the backbone 512. In an embodiment of the present invention, the corporate gateway 516 can be implemented as a transparent virtual private network (VPN) gateway at a corporate firewall. The corporate gateway 516 can be coupled to an external communications network 530, for example, the Internet, via a communications line 518. The communications line 518 can be implemented as a plain old telephone service (POTS) line, a digital subscriber line (DSL), an integrated services digital network (ISDN) line, a TI or above line, a wireless link or the like. The coupling to and communication via the communications network 530 can be implemented using a SSL encryption protocol. An external user computer/terminal 520 can communicate with the corporate gateway 516 via a dial-in connection line 522, which can be implemented using similar technologies as described above for the communications line 518. The communications network 530 can be communicatively coupled to a provider VPN gateway 550, which can be configured to control access to a provider network 540. The provider network 540 can include a server computer 560 coupled to the provider VPN gateway 550 and an enterprise database 565 coupled to the server computer 560. In embodiments of the present invention, the server computer 560 can be implemented either as a single server computer or as a server array with multipleconnected server computers. In general, high-performance server computer systems are used to maximize system response times and throughput.

In another embodiment of the present invention, the provider network 540 can be implemented directly on the authorized stock option grantor corporate LAN 510.

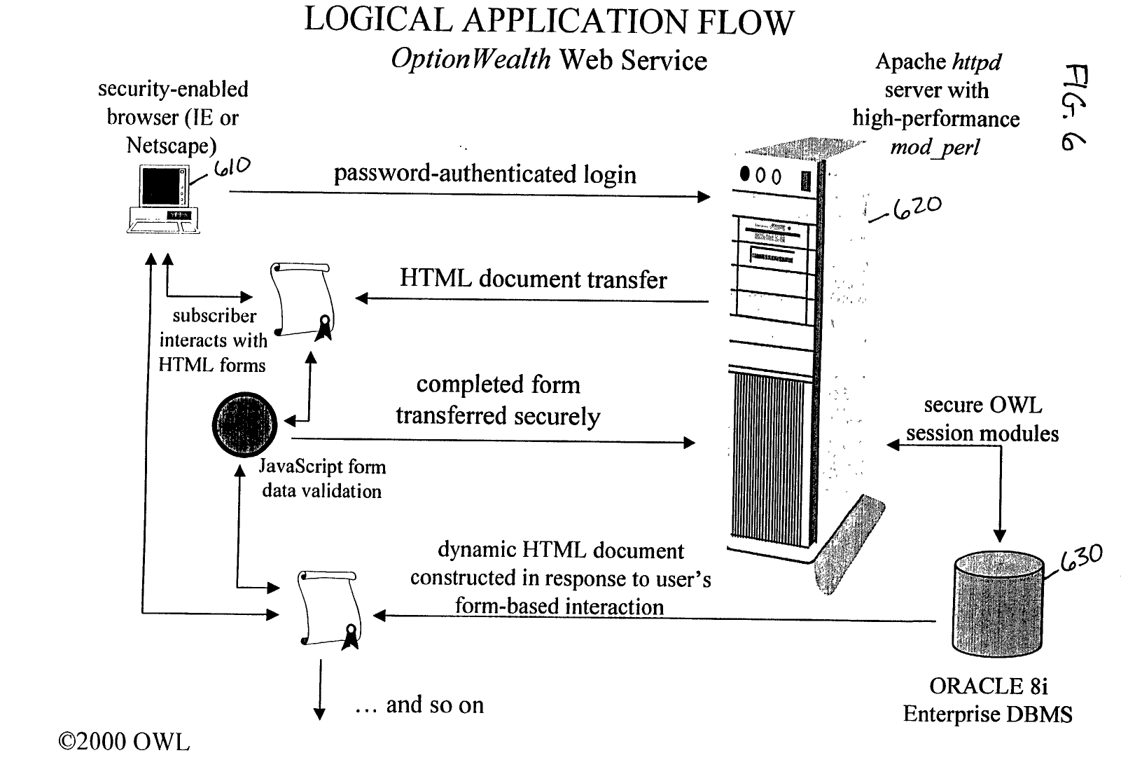

FIG. 6 illustrates a logical application flow for communications between a user and a system server computer, in accordance with an embodiment of the present invention. In FIG. 6, a user computer/terminal 610, which is configured with a security-enabled browser, for example, Internet Explorer or Netscape, can be used to logon to a server computer 620 with an enterprise database system 630 coupled to the server computer 620, using a password authenticated login sequence. In an embodiment of the present invention, the server computer 620 is configured to contain and execute a stock option management and optimization system and send an hypertext markup language (HTML),or other browser compatible, form to the user computer/terminal 610. A user at the user computer/terminal 610 interacts with the received HTML form and sends the completed form back to the server computer 620. The completed form is validated to ensure all necessary information has been provided. If information is missing the user can be prompted to provide the missing data or accept system default values. If the information on the completed form is validated, then the completed form can be transmitted to the server computer 620 as a secure document using SSL. The stock option management and optimization system can transmit to the user computer 610 dynamic HTML documents that can be constructed in response to the user's prior form-based interaction. Similar to that described above, completed forms transmitted from the user computer 610 to the server computer 620 are validated to ensure all necessary information has been provided.

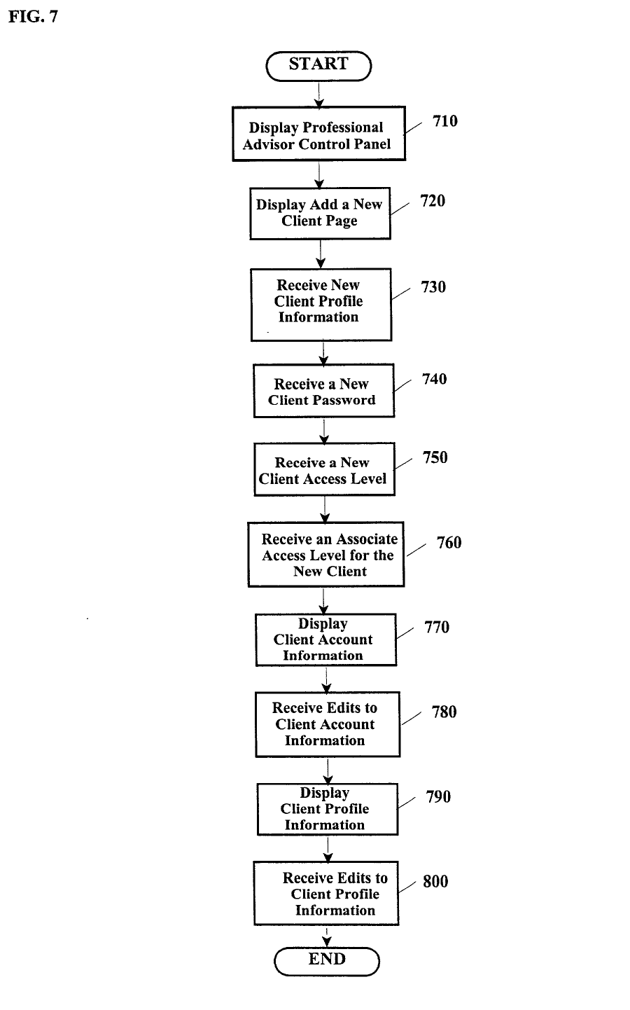

FIG. 7 illustrates a flow diagram for a method for providing a professional advisor control interface for optimizing the value of a stock option grant, in accordance with an embodiment of the present invention. In FIG. 7, a professional advisor control panel can be displayed 710 after a user logs onto a stock option management and optimization system as a supervisory-level user. The system can be configured to enable the user to add new client accounts and display 720 an add a new client page if that option is selected by the supervisory-level user. The system can to receive 730 new client account information, receive 740 a password for the new client account, and receive 750 a level of access for the new client account. Possible levels of client access include no access, view only access and standard, that is, normal user read and write access. The system also can be configured to provide the supervisory-level user with the option to grant access to the client account by trusted third-party associates, for example, other professional advisors associated with the granting professional advisor. Possible levels of supervisory-level access include no access, view only access and standard (that is, normal user read and write access), and supervisory-level access, which gives the associate the same rights to create accounts and grant access as the original supervisory-level user. The system can receive 760 the grants of the associate access levels from the supervisory-level user. The system can be configured to permit the supervisory-level user to view and/or edit (that is, add grants, create forecasts, prepare estimates for strategies, optimize a selected strategy, track selected strategies performances, etc.) client accounts and display 770 the client account information for use by the supervisory-level user. The system can receive 780 changes or additions made to the client account information. The system also can be configured to display 790 existing client profile information and to receive 800 changes to the existing client profile information.

In accordance with an embodiment of the present invention, the supervisory-level user or any associate granted supervisory-level access privileges to a client account can perform all of the normal tracker, forecaster, strategy and optimizer system functions described above.

In an embodiment of the present invention, a professional financial advisor can establish, maintain and grant access to individual accounts for each of the professional financial advisor's clients. The professional financial advisor can establish a client account by entering client specific information, stock option grant information and selecting a level of access privileges for the client. The client specific information can include, for example, e-mail address, user name, first name, last name, street address, city, state, zip code, company name, job title, telephone number, and password. In an embodiment of the present invention, the professional financial advisor must include at least one of the e-mail address or user name to be used as the clients identification (ID); the first name; the last name; the street address; the city; the state; the zip code; the telephone number; and the password. The stock option grant information can include, for example, a stock identifier, a grant type, an option grant date, a number of shares granted, an option price, and an expiration date for the option. The levels of access privileges that can be granted can include no access, view-only (that is, read-only access privileges), standard (that is, both read and write access privileges) and professional (that is, access for the professional financial advisor's peers with either no access, view-only and/or standard access privileges). In accordance with an embodiment of the present invention, the client's account is secured from access by unauthorized users through the use of the individual client's ID and password.

In accordance with an embodiment of the present invention, once the professional financial advisor has established the client account the client can logon to the system using the assigned ID and password and perform all of the above described tracking, forecasting, strategizing and optimizing, limited only by the client's level of access.

Additional embodiments of the present invention are contemplated that will integrate with and leverage emerging a) standards, b) work and lifestyles, c) external business models (a.k.a. “business to business,” “B2B”), and d) human capabilities and limitations. These contemplated embodiments can:

Deliver Tracker Alerts to any Internet-enabled device, including, but not limited to, Palm® PCs, Windows® CE computers, mobile phones, pagers, televisions and automobiles.

Support the new web clipping technology.

Share information with office productivity tools and database management systems using open standards such as ODBC.

Integrate system Toolbox services within third party products and corporate Intranets using the system's OpenOWL technology. “OpenOWL” will allow parties such as portal web sites, financial services providers and companies with optioned employees to deliver OptionWealth's Toolbox functionality to their customers while maintaining the “look and feel” and business context of their own products and organizations.

Add voice recognition, audio feedback and audio glossary human-computer interface to all OptionWealth Toolbox products.

Channel timely “optionee”-oriented educational and informational content to the user in an interactive multimedia experience via the system's InfoCenter. The user will can the InfoCenter and, for example, take part in a seminar on stock options; interact with OptionWealth affiliate partners of the legal, accounting, and estate planning and financial service professions; or perhaps listen to the audio version of Optionaire Notes, which provides news and information for optionees.

Embodiments of the present invention may be utilized for all employee stock options, and enable option holders and their advisors to personalize strategies based on each, individual option holder's situation. In an embodiment of the present invention, the suite of system tools can be delivered as an application system provider (ASP), which will decrease operating costs and the costs to customers, facilitate upgrades to the system products and services, and enable maintaining greater security over the information on the system. The system web site can contain detailed information (“content”) relating to stock options, which can provide option holders with an objective source for understanding their options. As employees begin to more effectively manage their own stock option portfolios, employers will realize greater benefits from their grants of these stock options. In accordance with an embodiment of the present invention, the system has also been designed to integrate with a company's existing compensation databases and legacy software.

In accordance with an embodiment of the present invention, the system is designed to take advantage of and become an integral part of the current infrastructure and distribution systems surrounding employee stock options. The system provides the “last mile” needed to successfully bridge the optionee to the company/advisors.

In an embodiment of the present invention, the system tools will be configured to assist securities and financial professionals who advise option holders on accounting, legal, generational, financial planning, and option exercise issues. The system tools will provide these professionals with an additional process by which they may manage their current client's assets and attract the assets of the wealthiest American's. Securities firms and financial institutions will be compelled to “resell” the system tools to their corporate clients in order to attract additional assets.

In an embodiment of the present invention, the system will work with systems from the companies currently supplying the data warehousing function for the optionee data, including, for example, software/database companies, outsourcers, and transfer agents. This will enable embodiments of the present invention to quickly access the 4,000,000 optionees in these current systems with minimal integration. For example, one embodiment of the conversion model can be leveraged across all the clients in a particular database.

In accordance with an embodiment of the present invention, the system is intended to be marketed directly to employers that grant employee stock options. In an embodiment of the present invention, employers can benefit by providing their employees with access to the web site embodiment of the system. This can mitigate the burden placed on human resources departments, which are experiencing increased demands for information and advice regarding employee stock options. Providing access to the system tools, in accordance with an embodiment of the present invention, can help companies increase their employee retention and productivity.

In an embodiment of the present invention, the system's core business features annual subscription access to web-based analytic and educational tools that can be targeted, for example, to three market segments: 1) medium to large financial institutions such as banks, broker-dealers, accountants and compensation consultants, 2) companies providing software that warehouses optionee data, and 3) accounts with middle and large option granting companies. These are market segments where subscribers can be captured quickly and in the largest numbers.

In an embodiment of the present invention, the business model focuses on developing and expanding long-term relationships within the existing infrastructure, that is, with advisors and distribution channels, to increase assets under management, since bypassing human relationships Ad at the high net worth level is doomed to failure. For these reasons, the system's tools and services are designed to be used within a planning practice and also resold through that practice's distribution channels to further the practice's asset and revenue goals. The reselling of embodiments of the present invention into corporate channels will allow employers to realize greater efficiencies both in their human resources departments and from their equity-incentive programs by integrating the present invention's tools with the existing equity compensation infrastructure of an employer.

In summary, the financial planning industry is redefining itself through the Internet. Specifically, the financial advisory industry is shifting away from its previous dependence on the personal relationship-based advisory model and is beginning to rely more on web distribution, web collaboration and web tools. However, implementation of the new strategies in the high net worth arena will still require a “trusted advisor” relationship. Medium to large financial service firms will still hold most of the cards as they have already built customer trust and have established long-term relationships complete with permission to communicate with the client on the subject of wealth building. In accordance with an embodiment of the present invention, the system's consultant-centric tools along with targeted data allow the system's services to work through the current distribution channels of financial service providers to help them be more productive, gather more assets and generate additional revenue.

In accordance with an embodiment of the present invention, the system can provide a unique link between the advisor and the optionee to create a synergistic bond between the advisor and the optionee. This bond gives each party both the privacy and space they each need to balance the optionee/advisor communications in a manner that integrates the best of traditional one-on-one personal relationships with state-of-the-art 21^{st} century technology. This win/win outcome can create great value for the optionee while simultaneously allowing the financial institution to reach its goals of asset growth.

In accordance with an embodiment of the present invention, a method for optimizing the value of stock option grants using a communications network, the method includes receiving an option-exercising scenario for a stock option grant; calculating an estimate for the optionexercising scenario for the stock option grant; comparing the estimate for the option-exercising scenario for the stock option grant against an estimate based on a standard strategy optionexercising scenario; and calculating an optimal strategy to maximize the value of the stock option grant based on one of the estimate for the option-exercising scenario for the stock option grant and the estimate based on the standard strategy option-exercising scenario.

In accordance with an embodiment of the present invention, a machine-readable medium having stored thereon a plurality of executable instructions for optimizing the value of stock option grants, the plurality of executable instructions including instructions to: receive an optionexercising scenario for a stock option grant; calculate an estimate for the option-exercising scenario for the stock option grant; compare the estimate for the option-exercising scenario for the stock option grant against an estimate based on a standard strategy option-exercising scenario; and calculate an optimal strategy to maximize the value of the stock option grant based on one of the estimate for the option-exercising scenario for the stock option grant and the estimate based on the standard strategy option-exercising scenario.

In accordance with an embodiment of the present invention, a method for optimizing the value of stock option grants using a communications network, the method including: receiving a plurality of option-exercising scenarios for a stock option grant; calculating an estimate for each of the plurality of option-exercising scenarios for the stock option grant; comparing the estimate for each of the plurality of option-exercising scenarios for the stock option grant against an estimate based on at least one standard strategy option-exercising scenario; and calculating an optimal strategy to maximize the value of the stock option grant based on one of the estimates for the plurality of option-exercising scenarios for the stock option grant and the estimate based on the at least one standard strategy option-exercising scenario.

In accordance with an embodiment of the present invention, a method for optimizing the value of stock option grants, the method including: establishing an account for a client; assigning a password to the account; assigning a client access level to the account; receiving information describing a stock option grant; receiving an option-exercising scenario for the stock option grant; calculating an estimate for the option-exercising scenario for the stock option grant; comparing the estimate for the option-exercising scenario for the stock option grant against an estimate based on a standard strategy option-exercising scenario; and calculating an optimal strategy to maximize the value of the stock option grant based on one of the estimate for the option-exercising scenario for the stock option grant and the estimate based on the standard strategy option-exercising scenario.

In accordance with an embodiment of the present invention, a machine-readable medium having stored thereon a plurality of executable instructions for optimizing the value of stock option grants, the plurality of executable instructions including instructions to: establish an account for a client; assign a password to the account; assign a client access level to the account; receive information describing a stock option grant; receive an option-exercising scenario for the stock option grant; calculate an estimate for the option-exercising scenario for the stock option grant; compare the estimate for the option-exercising scenario for the stock option grant against an estimate based on a standard strategy option-exercising scenario; and calculate an optimal strategy to maximize the value of the stock option grant based on one of the estimate for the option-exercising scenario for the stock option grant and the estimate based on the standard strategy option-exercising scenario.

In accordance with an embodiment of the present invention, an apparatus for optimizing the value of stock option grants, the apparatus including: a server computer system configured to communicate with a plurality of user computer systems; and a computer program stored in the server computer system, the computer program including: a tracking module; a forecasting module; a strategy module; and an optimizing module.

In accordance with an embodiment of the present invention, an apparatus for optimizing the value of a stock option grant, the apparatus including: means for tracking a stock option grant; means for forecasting a plurality of values for the stock option grant; means for determining strategies to exercise the stock option grant; and means for optimizing a strategy to maximize the value of the stock option grant.

It should, of course, be understood that while the present invention has been described mainly in terms of microprocessor-based and multiple microprocessor-based personal computer systems, those skilled in the art will recognize that the principles of the invention, as discussed herein, may be used advantageously with alternative embodiments involving other integrated processor chips and computer systems. Accordingly, all such implementations which fall within the spirit and scope of the appended claims will be embraced by the principles of the present invention.

What is claimed is:

1. A method for optimizing the value of stock option grants using a communications network, the method comprising:
receiving an option-exercising scenario for a stock option grant;
calculating an estimate for the option-exercising scenario for the stock option grant;
comparing the estimate for the option-exercising scenario for the stock option grant against an estimate based on a standard strategy option-exercising scenario; and
calculating an optimal strategy to maximize the value of the stock option grant based on one of the estimate for the option-exercising scenario for the stock option grant and the estimate based on the standard strategy option-exercising scenario.

2. The method of claim 1, further comprising:
receiving a request to access a stock option management system via the communications network; and
granting access to the stock option management system.

3. The method of claim 2, wherein the receiving a request to access the stock option management system via the communications network comprises:
receiving a user request to logon to the stock option management system;
requesting user identification information;
receiving the user identification information; and
verifying the user identification information.

4. The method of claim 2, wherein the granting access to the stock option management system comprises:
establishing a secure connection to the user.

5. The method of claim 1, further comprising:
receiving information on the stock option grant, the information including:
an identification of a stock;
a grant date;
a total number of shares;
a vesting schedule for the total number of shares;
an option price; and
an expiration date.

6. The method of claim 1, further comprising:
calculating a future price curve for a stock, wherein calculating the future price curve for the stock includes:
displaying a company associated with the stock;
receiving a selection of the company associated with the stock;
receiving an historical returns period selection for the stock;
receiving a time period for which to calculate the forecast;
receiving at least one estimated future price for the stock;
receiving a confidence level for the at least one future price;
receiving a level of accuracy for the analysis.
calculating the future price curve;
displaying the future price curve with an indication of the likelihood of achieving each price on the future price curve;
saving selected price point forecasts from the price curve;
displaying the saved price point forecasts.

7. The method of claim 6, wherein the at least one future price defines the price of the stock one year and one day from the date of the option grant.

8. The method of claim 6, wherein the at least one future price is at least one of.
a most likely future stock price;
a worst case future stock price; and
a best case future stock price.

9. The method of claim 6, wherein the confidence level specifies a level of historical stock performance to be used to calculate a forecast for one of the at least one future price of the stock.

10. The method of claim 6, wherein the confidence level is measured on a continuous scale, the continuous scale ranging from a low confidence level to a high confidence level.

11. The method of claim 6, wherein a low confidence level indicates the use of the stock's historical performance to calculate the forecast.

12. The method of claim 6, wherein a high confidence level indicates the use of the at least one future price to calculate the forecast.

13. The method of claim 6, wherein a medium confidence level indicates the use of approximately 50% of the stock's historical performance and approximately 50% of the at least one future price to calculate the forecast.

14. The method of claim 1, wherein receiving an option-exercising scenario for a stock option grant comprises:
receiving a selection of a stock for the option-exercising scenario;;
receiving information on how to execute the option-exercising scenario;
receiving information on how to fund the exercise of the option-exercising scenario; and
receiving tax information for the option-exercising scenario.

15. The method of claim 1, wherein comparing the estimate for the option-exercising scenario for the stock option grant against an estimate based on a standard strategy optionexercising scenario comprises:
calculating the estimate based on a black-scholes-based strategy option-exercising scenario using information received on how to execute and fund the option-exercising scenario and tax information received for the option-exercising scenario; and
displaying the estimate for the option-exercising scenario for the stock option grant with the estimate based on a standard strategy option-exercising scenario.

16. The method of claim 1, wherein calculating an optimal strategy to maximize the value of the stock option grant based on one of the estimate for the option-exercising scenario for the stock option grant and the estimate based on the standard strategy option-exercising scenario comprises:
receiving a selection of one of the estimate for the option-exercising scenario for the stock option grant and the estimate based on the standard strategy option-exercising scenario;
receiving risk tolerance information;
receiving financial ability information;
calculating the optimal strategy for the selected estimate using the risk tolerance information and the financial ability information.

17. The method of claim 16, wherein the calculating the optimal strategy for the selected estimate using the risk tolerance information and the financial ability information comprises:
calculating the optimal strategy for the selected estimate using the risk tolerance information, the financial ability information and accounting, legal, estate planning and financial planning best practices information.

18. A machine-readable medium having stored thereon a plurality of executable instructions for optimizing the value of stock option grants, the plurality of executable instructions comprising instructions to:
receive an option-exercising scenario for a stock option grant;
calculate an estimate for the option-exercising scenario for the stock option grant;
compare the estimate for the option-exercising scenario for the stock option grant against an estimate based on a standard strategy option-exercising scenario; and
calculate an optimal strategy to maximize the value of the stock option grant based on one of the estimate for the option-exercising scenario for the stock option grant and the estimate based on the standard strategy option-exercising scenario.

19. The machine-readable medium of claim 18, further comprising instructions to:
receive a request to access a stock option management system; and
grant access to the stock option management system.

20. The machine-readable medium of claim 19, wherein the receive a request to access a stock option management system instruction comprises instructions to:
receive a user request to logon to the stock option management system;
request user identification information;
receive the user identification information; and
verify the user identification information.

21. The machine-readable medium of claim 19, wherein the grant access to the stock option management system instruction comprises an instruction to:
establish a secure connection to the user.

22. The machine-readable medium of claim 18, further comprising an instruction to:
receive information on the stock option grant.

23. The machine-readable medium of claim 19, further comprising instructions to:
calculate a future price curve for a stock, wherein the calculate the future price curve for the stock instruction includes instructions to:
display a company associated with the stock;
receive a selection of the company associated with the stock;
receive an historical returns period selection for the stock;
receive a time period for which to calculate the forecast;
receive at least one estimated future price for the stock;
receive a confidence level for the at least one future price;
receive a level of accuracy for the analysis.
calculate the future price curve;
display the future price curve with an indication of the likelihood of achieving each price on the future price curve;
save selected price point forecasts from the price curve;
display the saved price point forecasts.

24. The machine-readable medium of claim 18, wherein the receiving an optionexercising exercising scenario for a stock option grant instruction comprises instructions to:
receive a selection of a stock for the option-exercising scenario;;
receive information on how to execute the option-exercising scenario;
receive information on how to fund the exercise of the option-exercising scenario; and
receive tax information for the option-exercising scenario.

25. The machine-readable medium of claim 18, wherein the compare the estimate for the option-exercising scenario for the stock option grant against an estimate based on a standard strategy option-exercising scenario instruction comprises instructions to:
calculate the estimate based on a standard strategy option-exercising scenario using information received on how to execute and fund the option-exercising scenario and tax information received for the option-exercising scenario; and
display the estimate for the option-exercising scenario for the stock option grant with the estimate based on a standard strategy option-exercising scenario.

26. The machine-readable medium of claim 18, wherein the calculate an optimal strategy to maximize the value of the stock option grant based on one of the estimate for the option-exercising scenario for the stock option grant and the estimate based on the standard strategy option-exercising scenario instruction comprises instructions to:
receive a selection of one of the estimate for the option-exercising scenario for the stock option grant and the estimate based on the standard strategy option-exercising scenario;
receive risk tolerance information;
receive financial ability information;
calculate the optimal strategy for the selected estimate using the risk tolerance information and the financial ability information.

27. The machine-readable medium of claim 26, wherein the calculate the optimal strategy for the selected estimate using the risk tolerance information and the financial ability information instruction comprises an instruction to:
calculate the optimal strategy for the selected estimate using the risk tolerance information, the financial ability information and accounting, legal, estate planning and financial planning best practices information.

28. A method for optimizing the value of stock option grants using a communications network, the method comprising:
receiving a plurality of option-exercising scenarios for a stock option grant;
calculating an estimate for each of the plurality of option-exercising scenarios for the stock option grant;
comparing the estimate for each of the plurality of option-exercising scenarios for the stock option grant against an estimate based on at least one standard strategy option-exercising scenario; and
calculating an optimal strategy to maximize the value of the stock option grant based on one of the estimates for the plurality of option-exercising scenarios for the stock option grant and the estimate based on the at least one standard strategy option-exercising scenario.

29. A method for optimizing the value of stock option grants, the method comprising:
establishing an account for a client;
assigning a password to the account;
assigning a client access level to the account;
receiving information describing a stock option grant;
receiving an option-exercising scenario for the stock option grant;
calculating an estimate for the option-exercising scenario for the stock option grant;
comparing the estimate for the option-exercising scenario for the stock option grant against an estimate based on a standard strategy option-exercising scenario; and
calculating an optimal strategy to maximize the value of the stock option grant based on one of the estimate for the option-exercising scenario for the stock option grant and the estimate based on the standard strategy option-exercising scenario.

30. The method of claim 29, further comprising:
receiving a request to access a stock option management system via the communications network; and
granting access to the stock option management system.

31. The method of claim 30, wherein the receiving a request to access a stock option management system via the communications network comprises:
receiving a user request to logon to the stock option management system;
requesting user identification information;
receiving the user identification information; and
verifying the user identification information.

32. The method of claim 30, wherein the granting access to the stock option management system comprises:
establishing a secure connection to the user.

33. The method of claim 29, further comprising:
receiving information on the stock option grant, the information including:
an identification of a stock;
a grant date;
a total number of shares;
a vesting schedule for the total number of shares;
an option price; and
an expiration date.

34. The method of claim 29, further comprising:
calculating a future price curve for a stock, wherein calculating the future price curve for the stock includes:
displaying a company associated with the stock;
receiving a selection of the company associated with the stock;
receiving an historical returns period selection for the stock;
receiving a time period for which to calculate the forecast;
receiving at least one estimated future price for the stock;
receiving a confidence level for the at least one future price;
receiving a level of accuracy for the analysis;
calculating the future price curve;
displaying the future price curve with an indication of the likelihood of achieving each price on the future price curve;
saving selected price point forecasts from the price curve;
displaying the saved price point forecasts.

35. The method of claim 34, wherein the at least one future price defines the price of the stock one year and one day from the date of the option grant.

36. The method of claim 34, wherein the at least one future price is at least one of:
a most likely future stock price;
a worst case future stock price; and
a best case future stock price.

37. The method of claim 34, wherein the confidence level specifies a level of historical stock performance to be used to calculate a forecast for one of the at least one future price of the stock.

38. The method of claim 30, further comprising:
receiving a level of analysis at which to calculate a forecast for at least one future price.

39. The method of claim 29, wherein calculating an optimal strategy to maximize the value of the stock option grant based on one of the estimate for the option-exercising scenario for the stock option grant and the estimate based on the standard strategy option-exercising scenario comprises:
receiving a selection of one of the estimate for the option-exercising scenario for the stock option grant and the estimate based on the standard strategy option-exercising scenario;
receiving risk tolerance information;
receiving financial ability information;
calculating the optimal strategy for the selected estimate using the risk tolerance information and the financial ability information.

40. The method of claim 29, further comprising:
granting a third party access privileges to access the client account.

41. The method of claim 40, wherein granting a third party access privileges to access the client account comprises:
selecting a third party;
selecting an access level for the third party;
selecting a client account; and
granting the third party access to the client account at the selected access level.

42. The method of claim 40, further comprising:
revoking the third party access privileges to access the client account.

43. A machine-readable medium having stored thereon a plurality of executable instructions for optimizing the value of stock option grants, the plurality of executable instructions comprising instructions to:
establish an account for a client;
assign a password to the account;
assign a client access level to the account;
receive information describing a stock option grant;
receive an option-exercising scenario for the stock option grant;
calculate an estimate for the option-exercising scenario for the stock option grant;
compare the estimate for the option-exercising scenario for the stock option grant against an estimate based on a standard strategy option-exercising scenario; and
calculate an optimal strategy to maximize the value of the stock option grant based on one of the estimate for the option-exercising scenario for the stock option grant and the estimate based on the standard strategy option-exercising scenario.

44. The machine-readable medium of claim 43, further comprising instructions to:
receive a request to access a stock option management system via the communications network; and
grant access to the stock option management system.

45. The machine-readable medium of claim 44, wherein the receive a request to access a stock option management system via the communications network instructions comprises instructions to:
receive a user request to logon to the stock option management system;
request user identification information;
receive the user identification information; and
verify the user identification information.

46. The machine-readable medium of claim 44, wherein the grant access to the stock option management system instruction comprises an instruction to:
establishing a secure connection to the user.

47. The machine-readable medium of claim 43, further comprising instructions to: receive information on the stock option grant, the information including:
an identification of a stock;
a grant date;
a total number of shares;
a vesting schedule for the total number of shares;
an option price; and
an expiration date.

48. The machine-readable medium of claim 43, further comprising instructions to:
calculate a future price curve for a stock, wherein calculating the future price curve for the stock includes:
display a company associated with the stock;
receive a selection of the company associated with the stock;
receive an historical returns period selection for the stock;
receive a time period for which to calculate the forecast;
receive at least one estimated future price for the stock;
receive a confidence level for the at least one future price;
receive a level of accuracy for the analysis;
calculate the future price curve;
display the future price curve with an indication of the likelihood of achieving each price on the future price curve;
save selected price point forecasts from the price curve;
display the saved price point forecasts.

49. The machine-readable medium of claim 48, wherein the at least one future price defines the price of the stock one year and one day from the date of the option grant.

50. The machine-readable medium of claim 48, wherein the at least one future price is at least one of:
a most likely future stock price;
a worst case future stock price; and
a best case future stock price.

51. The machine-readable medium of claim 48, wherein the confidence level specifies a level of historical stock performance to be used to calculate a forecast for one of the at least one future price of the stock.

52. The machine-readable medium of claim 44, further comprising an instruction to:
receive a level of analysis at which to calculate a forecast for at least one future price.

53. The machine-readable medium of claim 43, wherein determining an optimal strategy to maximize the value of the stock option instruction comprises an instruction to:
determine a best option-exercising scenario from the forecasts for each of the plurality of option-exercising scenarios and the at least one forecast for the standard strategy optionexercising scenario.

54. The machine-readable medium of claim 43, further comprising an instruction to:
grant a third party access privileges to access the client account.

55. The machine-readable medium of claim 43, wherein the grant a third party access privileges to access the client account instruction comprises instructions to:
select a third party;
select an access level for the third party;
select a client account; and
grant the third party access to the client account at the selected access level.

56. The machine-readable medium of claim 43, further comprising an instruction to:
revoke the third party access privileges to access the client account.

57. An apparatus for optimizing the value of stock option grants, the apparatus comprising:
a server computer system configured to communicate with a plurality of user computer systems; and
a computer program stored in the server computer system, the computer program including:
a tracking module;
a forecasting module;
a strategy module; and
an optimizing module.

58. The apparatus of claim 57, wherein the server computer system is further configured to communicate with the plurality of user computer systems via a communications network.

59. The apparatus of claim 58, wherein the communications network comprises at least one of:
a local area network;
a wide area network;
a telecommunications network;
a digital data network; and
a wireless communications network.

60. The apparatus of claim 57, wherein the tracking module comprises instructions to:
receive stock option grant information;
track the stock option grant information;
receive held stock shares information;
track the held stock shares information;
perform valuations of the stock option grant and held stock shares;
provide an alert of an approaching grant vesting date for the stock option grant;
provide an alert of an approaching grant expiration dates for the stock option grant;
provide a number of days remaining to reduced capital gains tax for the stock option grant;
analyze the performance of a current stock option-exercising strategy for the stock option grant;
receive information to dispose of shares in the stock option grant; and
provide accounting information on all acquired and disposed of shares of the stock option grant.

61. The apparatus of claim 57, wherein the forecasting module comprises instructions to:
receive forecast information for the stock option grant;
receive a level of analysis at which to perform a forecast for the stock option grant;
calculate the forecast for the stock option grant;
display the forecast for the stock option grant; and
save the forecast for the stock option grant.

62. The apparatus of claim 57, wherein the strategy module comprises instructions to:
receive a selection of the stock option grant;
receive information which specifies how to exercise the stock option grant;
calculate a strategy to exercise the stock option grant;
compare the strategy to exercise the stock option grant with a scenario calculated using a standard strategy for the stock option grant;
save the strategy, if the strategy is selected; and
save the scenario calculated using a standard strategy, if the scenario is selected.

63. The apparatus of claim 57, wherein the optimizer module comprises instructions to:
receive a selected strategy to be optimized;
receive risk tolerance information;
receive financial ability information;
calculate an optimized plan for the selected strategy using the risk tolerance information, the financial ability information and best professional practices information.

64. An apparatus for optimizing the value of a stock option grant, the apparatus comprising:
means for tracking a stock option grant;
means for forecasting a plurality of values for the stock option grant;
means for determining strategies to exercise the stock option grant; and
means for optimizing a strategy to maximize the value of the stock option grant.

65. The apparatus of claim 64, further comprising:
means for receiving a request to access the means for optimizing the value of the stock option grant; and
means for granting access to the means for optimizing the value of the stock option grant.

66. The apparatus of claim 64, further comprising:
means for receiving information describing the stock option grant.

67. The apparatus of claim 64, further comprising:
means for receiving a level of analysis at which to calculate a forecast for at least one future price.

68. The apparatus of claim 64, wherein the means for tracking a stock option grant comprises:
means for transmitting summary information on the stock option grant;
means for managing information on the stock option grant;
means for managing information on held shares from the stock option grant;
means for managing accounting information for the stock option grant;
means for entering global edits; and
means for transmitting alerts related to the stock option grant.

69. The apparatus of claim 64, wherein the means for forecasting a stock option grant comprises:
means for estimating a plurality of future values for the stock option grant;
means for displaying the plurality of future values for the stock option grant; and
means for saving selected values for the stock option grant.

70. The apparatus of claim 64, wherein the means for determining strategies to exercise the stock option grant comprises:
means for performing what-if scenario calculations;
means for performing cash flow analysis;
means for comparing the what-if scenario calculations against at least one standard strategy;
means for determining rates of return for each what-if scenario; and
means for saving the plurality of future values for the stock option grant.

71. The apparatus of claim 64, wherein the means for optimizing a strategy to
maximize the value of the stock option grant comprises:
means for assessing financial goals;
means for assessing risk tolerances;
means for assessing financial abilities;
means for calculating an optimized plan; and
means for saving the optimized plan.

72. An apparatus for optimizing the value of a stock option grant, the apparatus comprising:
means for communicating with a user computer system;
means for tracking a stock option grant;
means for forecasting a plurality of values for the stock option grant;
means for determining strategies to exercise the stock option grant; and
means for optimizing a strategy to maximize the value of the stock option grant.
